(19) United States
(12) Patent Application Publication
(10) Pub. No.: US 2024/0064647 A1
(43) Pub. Date: Feb. 22, 2024

(54) MODEM CHIP, COMMUNICATION DEVICE USING THE SAME AND METHOD FOR DYNAMIC CONTROLLING THE SAME

(71) Applicant: MEDIATEK Inc., Hsinchu City (TW)

(72) Inventors: Da-Hong HE, Hsinchu City (TW); Chun-Wei SU, Hsinchu City (TW)

(21) Appl. No.: 18/449,726

(22) Filed: Aug. 15, 2023

Related U.S. Application Data
(60) Provisional application No. 63/371,771, filed on Aug. 18, 2022.

(51) Int. Cl. H04W 52/02

(52) U.S. Cl. CPC H04W 52/0274; H04W 52/0258

(57) ABSTRACT

A modem chip, a communication device using the same and a method for dynamic controlling the same are provided. The method for dynamic controlling the modem chip includes the following steps. At least one traffic type factor or at least one channel condition factor is estimated. A cell-specific reference signal (CRS) reception mode is decided according to the traffic type factor or the channel condition factor. At least one hardware parameter is set according to the CRS reception mode to receive a plurality of cell-specific reference signals fully or partially.

This application claims the benefit of U.S. provisional application Ser. No. 63/371,771, filed Aug. 18, 2022, the disclosure of which is incorporated by reference herein in its entirety.

### TECHNICAL FIELD

The disclosure relates in general to a chip, an electronic device using the same and a method for controlling the same, and more particularly to a modem chip, a communication device using the same and a method for dynamic controlling the same.

### BACKGROUND

Communication technologies have been developed rapidly. The communication technologies have been applied to several kinds of electric devices. For example, Long-Term Evolution (LTE) is a standard for wireless communication of high-speed data for mobile phones and data terminals. It is based on the GSM/EDGE and UMTS/HSPA network technologies, increasing the capacity and speed using a different radio interface together with core network improvements. 5th Generation (5G) New Radio (NR) 5G NR is a newly developed wireless communication technology.

In order to provide more efficient communication services and improve user experience, researchers are working on any method for reducing power consumption of a communication device in wireless communication.

### SUMMARY

The disclosure is directed to a modem chip, a communication device using the same and a method for dynamic controlling the same. At least one traffic type factor, at least one channel condition factor, a synchronization state of a synchronization circuit or a channel estimation state of a channel estimation circuit is obtained, and a cell-specific reference signal (CRS) reception mode is decided accordingly to receive a plurality of cell-specific reference signals fully or partially. As such, the power consumption of the communication device could be reduced according to different scenarios.

According to one embodiment, a method for dynamic controlling a modem chip is provided. The method for dynamic controlling the modem chip includes the following steps. At least one traffic type factor or at least one channel condition factor is estimated. A cell-specific reference signal (CRS) reception mode is decided according to the traffic type factor or the channel condition factor. At least one hardware parameter is set according to the CRS reception mode to receive a plurality of cell-specific reference signals fully or partially.

According to another embodiment, a modem chip is provided. The modem chip includes a baseband processing circuit, a Dynamic Voltage and Frequency Scaling (DVFS) circuit and a controller. The controller is coupled to the baseband processing circuit and the DVFS circuit. The controller is configured to obtain at least one traffic type factor or at least one channel condition factor, decide a cell-specific reference signal (CRS) reception mode according to the traffic type factor or the channel condition factor, and set at least one hardware parameter of the baseband processing circuit or the DVFS circuit according to the CRS reception mode to receive a plurality of cell-specific reference signals fully or partially.

According to an alternative embodiment, a communication device is provided. The communication device includes an antenna module, a radio transceiver and a modem chip. The radio transceiver is coupled to the antenna module. The modem chip is coupled to the radio transceiver. The modem chip includes a baseband processing circuit, a Dynamic Voltage and Frequency Scaling (DVFS) circuit and a controller. The controller is coupled to the baseband processing circuit and the DVFS circuit. The controller is configured to obtain at least one traffic type factor or at least one channel condition factor, decide a cell-specific reference signal (CRS) reception mode according to the traffic type factor or the channel condition factor, and set at least one hardware parameter of the baseband processing circuit or the DVFS circuit according to the CRS reception mode to receive a plurality of cell-specific reference signals fully or partially.

### BRIEF DESCRIPTION OF THE DRAWINGS

FIG. 1 shows a communication device receiving a plurality of cell-specific reference signals.

FIGS. 2A to 2D illustrate a cell-specific reference signal (CRS) reception mode of the communication device.

FIG. 3 shows a block diagram of the communication device.

FIGS. 4A to 4B show a flowchart of a method for dynamic controlling the modem chip.

FIG. 5 illustrates a synchronization state of a synchronization circuit.

FIG. 6 illustrates a channel estimation state of a channel estimation circuit.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

Certain terms are used in the specification and subsequent claims to refer to particular elements. The ordinary skill in the art will appreciate that a manufacturer may refer to the same element by different terms. This specification does not use the difference in name as a way to distinguish components, but use the difference in function of components as a criterion for distinguishing. The terms “including” and “comprising” mentioned throughout the specification and subsequent claims are open-ended terms, so they should be interpreted as “including but not limited to”. In addition, the term “coupled” herein includes any direct and indirect means of electrical connection. Indirect means of electrical connection include connection through other means.

A plurality of embodiments of the present disclosure will be referred to in detail, and the accompanying drawings are made to describe the embodiments of the present disclosure. The following description is some embodiments of the present disclosure, which is for the purpose of describing the principles of the present disclosure, not limiting the present invention. It can be understood that the embodiments of the present disclosure may be implemented by software, hardware, firmware or any combination thereof.

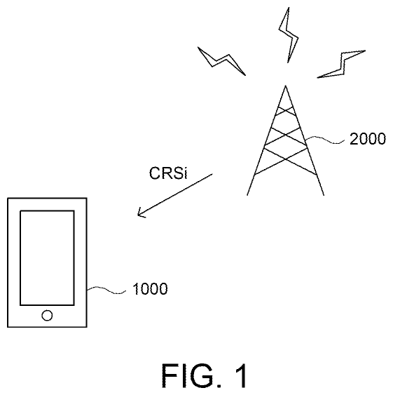

FIG. 1 shows a communication device 1000 (or called user equipment) receiving a plurality of cell-specific reference signals CRSi. The communication device 1000 is, for example, a cell phone, a notebook computer, a tablet computer or smart watch. A plurality of cell-specific reference signals CRSi are continuously transmitted by an eNodeB 2000 to the communication device 1000 as a cell specific pilot for multiple purpose for the communication device 1000, no matter there were physical downlink shared channel (PDSCH) or not. The eNodeB 2000 is, for example, a Macro cell or a Small cell, such as a Femtocell, a Picocell or a Microcell. If the communication device 1000 is not required high performance or is not encountered severe environmental interferences, the communication device 1000 could be dynamic controlled to balance the power consumption and user experience, such as throughput and latency.

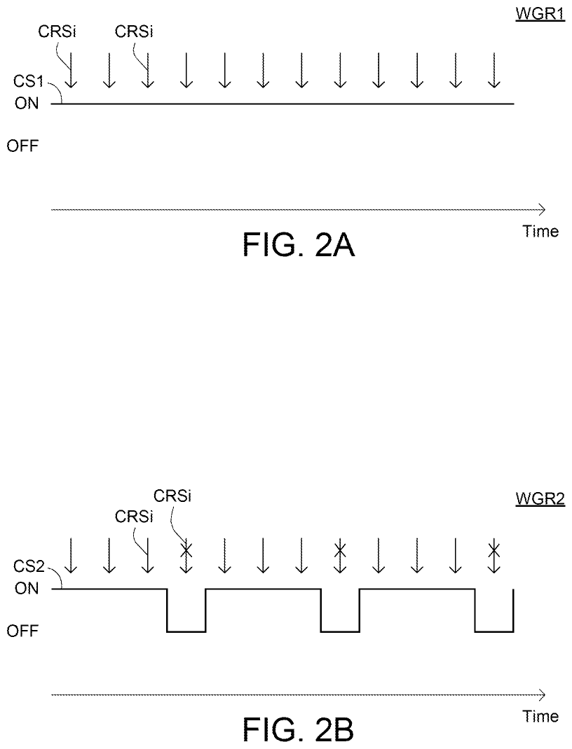

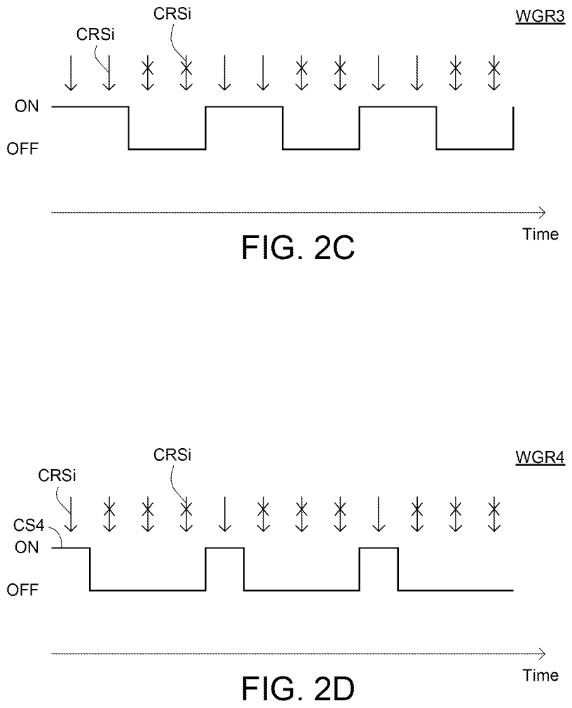

FIGS. 2A to 2D illustrate a cell-specific reference signal (CRS) reception mode of the communication device 1000. In this embodiment, the CRS reception of the communication device 1000 includes, for example, five working gears WGR1 to WGR5. The number of the working gears is not used to limit the present invention. As shown in FIG. 2A, in the working gear WGR1, a controlling signal CS1 used to receive the cell-specific reference signals CRSi is always at “ON” state, so the cell-specific reference signals CRSi is fully received.

As shown in FIG. 2B, in the working gear WGR2, most part of a controlling signal CS2 is at “ON” state and few part of the controlling signal CS2 is at “OFF” state, so most of the cell-specific reference signals CRSi are received and few of the cell-specific reference signals CRSi are not received. Comparing to the FIG. 2A, the power consumption of the communication device 1000 is reduced because few part of the controlling signal CS2 is at “OFF” state.

As shown in FIG. 2C, in the working gear WGR3, half part of a controlling signal CS3 is at “ON” state and half part of the controlling signal CS3 is at “OFF” state, so half of the cell-specific reference signals CRSi are received and half of the cell-specific reference signals CRSi are not received. Comparing to the FIG. 2B, the power consumption of the communication device 1000 is reduced because more part of the controlling signal CS3 is at “OFF” state.

As shown in FIG. 2D, in the working gear WGR4, few part of a controlling signal CS4 is at “ON” state and most part of the controlling signal CS4 is at “OFF” state, so few of the cell-specific reference signals CRSi are received and most of the cell-specific reference signals CRSi are not received. Comparing to the FIG. 2C, the power consumption of the communication device 1000 is reduced because more part of the controlling signal CS3 is at “OFF” state.

In this embodiment, the CRS reception mode of the communication device 1000 could be dynamically selected to receive the cell-specific reference signals CRSi fully or partially. As such, the power consumption of the communication device 1000 could be reduced according to different scenarios.

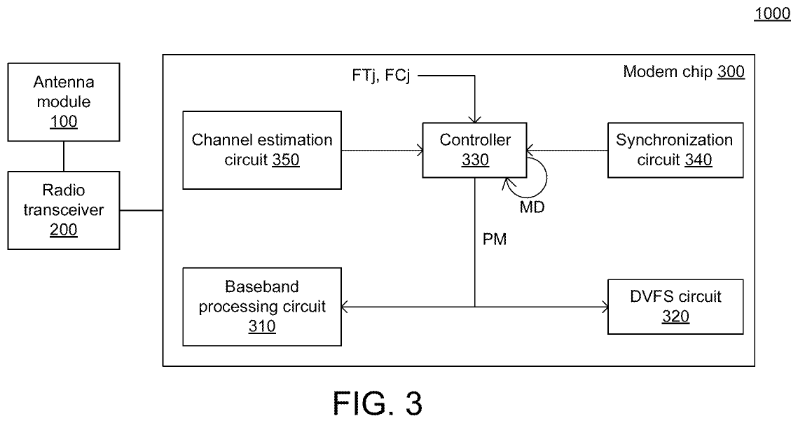

Please refer to FIG. 3, which shows a block diagram of the communication device 1000. The communication device 1000 includes an antenna module 100, a radio transceiver 200 and a modem chip 300. The radio transceiver 200 is coupled to the antenna module 100. The radio transceiver 200 is used to convert received signals into Intermediate Frequency (IF) signals or baseband signals to be processed, or receive IF signals or baseband signals from the modem chip 300 and convert them into radio frequency signals to be sent through the antenna module 100.

The modem chip 300 is coupled to the radio transceiver 200. The modem chip 300 includes a baseband processing circuit 310, a Dynamic Voltage and Frequency Scaling (DVFS) circuit 320, a controller 330, a synchronization circuit 340 and a channel estimation circuit 350. The baseband processing circuit 310 is coupled to the controller 330. The baseband processing circuit 310 includes, for example, a Radio Frequency Front-End (RFFE) circuit, a Radio Frequency Integrated Circuit (RFIC), an Analog-to-Digital Converter (ADC) or a digital hardware accelerator. The baseband processing circuit 310 is used for digital signal compression/decompression, channel encoding/decoding, interleaving/deinterleaving, encryption/decryption, formatting/deformatting, multiplexing/demultiplexing, modulation/demodulation, as well as computing tasks such as managing communication protocols and controlling input and output interfaces.

The DVFS circuit 320 is coupled to the controller 330. The DVFS circuit 320 is used for dynamic clock frequency adjustment and dynamic voltage adjustment to reduce power consumption and extend device life.

The synchronization circuit 340 is coupled to the controller 330. The synchronization circuit 340 is used for signal synchronization to prevent loss of data transmission.

The channel estimation circuit 350 is coupled to the controller 330. The channel estimation circuit 350 is used for channel measurement to ensure communication quality.

In the present embodiment, at least one traffic type factor FTj or at least one channel condition factor FCj is estimated, and the CRS reception mode MD is decided according to the traffic type factor FTj or the channel condition factor FCj. The operation of the modem chip 300 is illustrated via a flowchart.

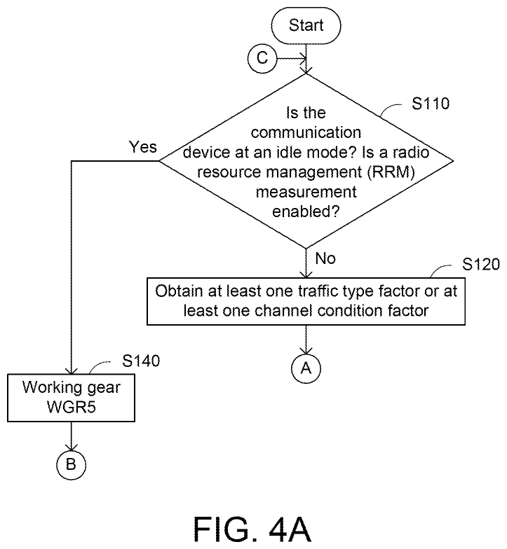

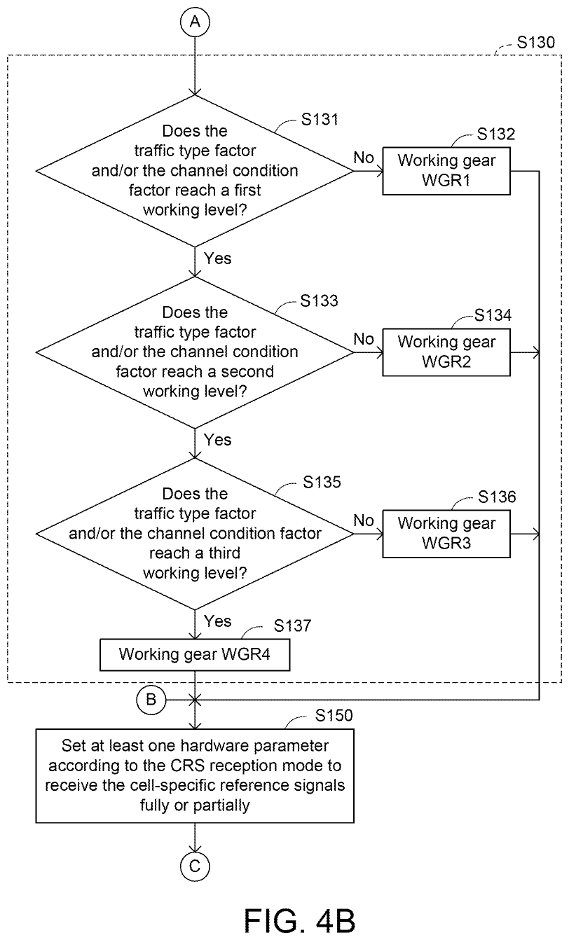

Please refer to FIGS. 4A to 4B, which show a flowchart of a method for dynamic controlling the modem chip 300. In step S110, the controller 330 determines whether the communication device 1000 is at an idle mode or a radio resource management (RRM) measurement is enabled. If the communication device 1000 is at the idle mode or the RRM measurement is enabled, the process proceeds to step S140; if the communication device 1000 is not at the idle mode and the RRM measurement is not enabled, the process proceeds to step S120.

In the step S140, the controller 330 decides the CRS reception mode MD to be the working gear WGR5. The working gear WGR5 is special gear for an idle mode or a radio resource management (RRM) measurement. In the working gear WGR5, only the cell-specific reference signals CRSi are received and other symbols are not needed to be received, because there is no PDCCH in this scenarios.

In step S120, the at least one traffic type factor FTj or the at least one channel condition factor FCj is obtained. The traffic type factor FTj is determined according to a transmission content, an operation of the communication device 1000 or an enabled application. The transmission content is, for example, video transmission, voice transmission, sparse data transmission, or physical downlink control channel (PDCCH) only. In one embodiment, the video transmission is classified as heavy traffic, the voice transmission, the sparse data transmission and the PDCCH only are classified as light traffic.

The channel condition factor FCj is, for example, a Block Error Rate (BLER), a Signal-to-Noise Ratio (SNR), a Reference Signal Received Power (RSRP), a mobility of the communication device 1000, a valid downlink sub-frame number or a cyclic redundancy check (CRC) error rate. In one embodiment, the lower the BLER, the mobility of the communication device 1000, the valid downlink sub-frame number or the CRC error rate, the better the channel condition factor FCj. The higher the SNR or the RSRP, the better the channel condition factor FCj.

Next, the process proceeds to the step S130. The step S130 includes the steps S131 to S137. In the step S130, the controller 330 decides the CRS reception mode MD according to the traffic type factor FTj or the channel condition factor FCj.

In the step S131, the controller 330 determines whether the traffic type factor FTj and/or the channel condition factor FCj reaches a first working level. The first working level is, for example, that the traffic type factor FTj is heavy traffic. The first working level is, for example, that the BLER (and/or the mobility of the communication device 1000, the valid downlink sub-frame number, the CRC error rate) is higher than a first threshold value. The first working level is, for example, that the SNR (and/or the RSRP) is lower than a first default value. If the first working level is reached, the process procced to the step S132; if the first working level is not reached, the process procced to the step S133.

In the step S132, the controller 330 decides the CRS reception mode to be the working gear WGR1.

In the step S133, the controller 330 determines whether the traffic type factor FTj and/or the channel condition factor FCj reaches a second working level. The second working level is, for example, that the traffic type factor FTj is light traffic. The second working level is, for example, that the BLER (and/or the mobility of the communication device 1000, the valid downlink sub-frame number, the CRC error rate) is higher than a second threshold value. The second threshold value is higher than the first threshold value. The second working level is, for example, that the SNR (and/or the RSRP) is lower than a second default value. The second default value is lower than the first default value. If the second working level is reached, the process procced to the step S134; if the second working level is not reached, the process procced to the step S135.

In the step S134, the controller 330 decides the CRS reception mode to be the working gear WGR2.

In the step S135, the controller 330 determines whether the traffic type factor FTj and/or the channel condition factor FCj reaches a third working level. The third working level is, for example, that the traffic type factor FTj is light traffic. The second working level is, for example, that the BLER (and/or the mobility of the communication device 1000, the valid downlink sub-frame number, the CRC error rate) is higher than a third threshold value. The third threshold value is higher than the second threshold value. The third working level is, for example, that the SNR (and/or the RSRP) is lower than a third default value. The third default value is lower than the second default value. If the third working level is reached, the process procced to the step S136; if the second working level is not reached, the process procced to the step S137.

In the step S136, the controller 330 decides the CRS reception mode to be the working gear WGR3.

In the step S137, the controller 330 decides the CRS reception mode to be the working gear WGR4.

That is to say, according to the traffic type factor FTj or the channel condition factor FCj, the CRS reception mode, such as the working gears WGR1 to WGR5, of the communication device 1000 could be dynamically selected to receive the cell-specific reference signals CRSi fully or partially. As such, the power consumption of the communication device 1000 could be reduced according to different scenarios.

Then, in step S150, the controller 330 sets at least one hardware parameter PM according to the CRS reception mode MD to receive the cell-specific reference signals CRSi fully or partially. The hardware parameter PM is, for example, a partial off time of the RFFE circuit, the RFIC, the ADC and/or the digital hardware accelerator of the baseband processing circuit 310.

Or, the hardware parameter PM is, for example, a setting voltage of the DVFS circuit 320.

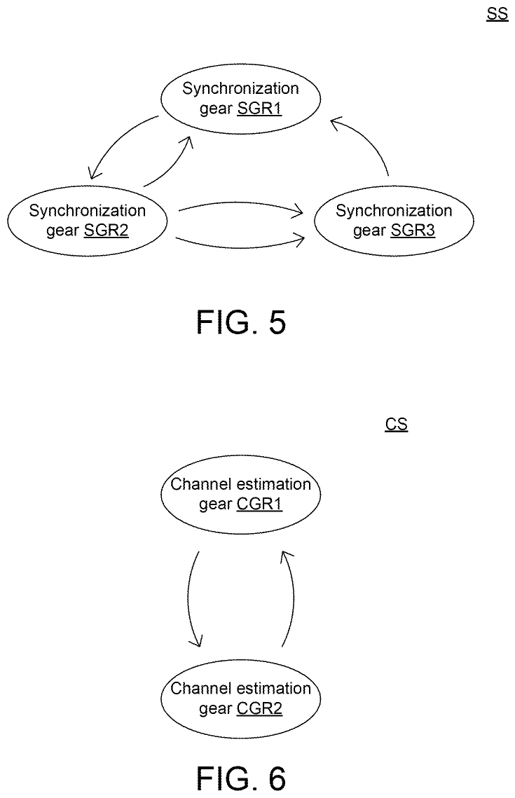

Please refer to FIG. 5, which illustrates a synchronization state SS of the synchronization circuit 340. The synchronization state of the synchronization circuit 340 includes a plurality of synchronization gears SGR1 to SGR3. Among the synchronization gears SGR1 to SGR3, the synchronization gear SGR1 has the largest number of the CRS symbols and the synchronization gear SGR3 has the lowest number of the CRS symbols. In one embodiment, the controller 330 may decide the CRS reception mode MD according to the synchronization state SS of the synchronization circuit 340.

Please refer to FIG. 6, which illustrates a channel estimation state SC of the channel estimation circuit 350. The channel estimation state SC of the channel estimation circuit 350 includes a plurality of channel estimation gears CGR1 and CGR2. Between the channel estimation gears CGR1 and CGR2, the channel estimation gear CGR1 has a larger number of the CRS symbols and the channel estimation gear CGR3 has a smaller number of the CRS symbols. In one embodiment, the controller 330 may decides the CRS reception mode MD according to the channel estimation state CS of the channel estimation circuit 350.

According to the embodiments describe above, the traffic type factor FTj, the channel condition factor FCj, the synchronization state SS of the synchronization circuit 340 or the channel estimation state CS of the channel estimation circuit 350 is obtained and the CRS reception mode MD is decided accordingly to receive the cell-specific reference signals CRSi fully or partially. As such, the power consumption of the communication device 1000 could be reduced according to different scenarios.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A method for dynamic controlling a modem chip, comprising:
obtaining at least one traffic type factor or at least one channel condition factor;
deciding a cell-specific reference signal (CRS) reception mode according to the traffic type factor or the channel condition factor; and
setting at least one hardware parameter according to the CRS reception mode to receive a plurality of cell-specific reference signals fully or partially.

2. The method for dynamic controlling the modem chip according to claim 1, wherein the CRS reception mode includes a plurality of working gears.

3. The method for dynamic controlling the modem chip according to claim 1, wherein the traffic type factor includes a transmission content.

4. The method for dynamic controlling the modem chip according to claim 1, wherein the channel condition factor is a Block Error Rate (BLER), a Signal-to-Noise Ratio (SNR), a Reference Signal Received Power (RSRP), a mobility of a communication device, a valid downlink sub-frame number or a cyclic redundancy check (CRC) error rate.

5. The method for dynamic controlling the modem chip according to claim 1, wherein the hardware parameter is a partial off time of a Radio Frequency Front-End (RFFE) circuit, a Radio Frequency Integrated Circuit (RFIC), an Analog-to-Digital Converter (ADC) or a digital hardware accelerator of a baseband processing circuit.

6. The method for dynamic controlling the modem chip according to claim 1, wherein the hardware parameter is a setting voltage of a Dynamic Voltage and Frequency Scaling (DVFS) circuit.

7. The method for dynamic controlling the modem chip according to claim 1, wherein the CRS reception mode is decided according to a synchronization state of a synchronization circuit, wherein the synchronization state includes a plurality of synchronization gears.

8. The method for dynamic controlling the modem chip according to claim 1, wherein the CRS reception mode is decided according to a channel estimation state of a channel estimation circuit, wherein the channel estimation state includes a plurality of channel estimation gears.

9. A modem chip, comprising:
a baseband processing circuit;
a Dynamic Voltage and Frequency Scaling (DVFS) circuit; and
a controller, coupled to the baseband processing circuit and the DVFS circuit, wherein the controller is configured to obtain at least one traffic type factor or at least one channel condition factor, decide a cell-specific reference signal (CRS) reception mode according to the traffic type factor or the channel condition factor, and set at least one hardware parameter of the baseband processing circuit or the DVFS circuit according to the CRS reception mode to receive a plurality of cell-specific reference signals fully or partially.

10. The modem chip according to claim 9, wherein the CRS reception mode includes a plurality of working gears.

11. The modem chip according to claim 9, wherein the traffic type factor includes a transmission content.

12. The modem chip according to claim 9, wherein the channel condition factor is a Block Error Rate (BLER), a Signal-to-Noise Ratio (SNR), a Reference Signal Received Power (RSRP), a mobility of a communication device, a valid downlink sub-frame number or a cyclic redundancy check (CRC) error rate.

13. The modem chip according to claim 9, wherein the hardware parameter is a partial off time of a Radio Frequency Front-End (RFFE) circuit, a Radio Frequency Integrated Circuit (RFIC), an Analog-to-Digital Converter (ADC) or a digital hardware accelerator of the baseband process circuit.

14. The modem chip according to claim 9, wherein the hardware parameter is a setting voltage of the DVFS circuit.

15. The modem chip according to claim 9, further comprising:
a synchronization circuit, coupled to the controller, wherein the controller is further configured to decide the CRS reception mode according to asynchronization state of the synchronization circuit, and the synchronization state includes a plurality of synchronization gears.

16. The modem chip according to claim 15, further comprising:
a channel estimation circuit, coupled to the controller, wherein the controller is further configured to decide the CRS reception mode according to a channel estimation state of the channel estimation circuit, and the channel estimation state includes a plurality of channel estimation gears.

17. A communication device, comprising:
an antenna module;
a radio transceiver, coupled to the antenna module; and
a modem chip, coupled to the radio transceiver, wherein the modem chip comprises:
a baseband processing circuit;
a Dynamic Voltage and Frequency Scaling (DVFS) circuit; and
a controller, coupled to the baseband processing circuit and the DVFS circuit, wherein the controller is configured to obtain at least one traffic type factor or at least one channel condition factor, decide a cell-specific reference signal (CRS) reception mode according to the traffic type factor or the channel condition factor, and set at least one hardware parameter of the baseband processing circuit or the DVFS circuit according to the CRS reception mode to receive a plurality of cell-specific reference signals fully or partially.

18. The communication device according to claim 17, wherein the CRS reception mode includes a plurality of working gears.

19. The communication device according to claim 17, wherein the channel condition factor is a Block Error Rate (BLER), a Signal-to-Noise Ratio (SNR), a Reference Signal Received Power (RSRP), a mobility of the communication device, a valid downlink sub-frame number or a cyclic redundancy check (CRC) error rate.

20. The communication device according to claim 17, wherein the hardware parameter is a partial off time of a Radio Frequency Front-End (RFFE) circuit, a Radio Frequency Integrated Circuit (RFIC), an Analog-to-Digital Converter (ADC) or a digital hardware accelerator of the baseband process circuit.
